(19) United States
(12) Patent Application Publication
(10) Pub. No.: US 2006/0219886 A1
(43) Pub. Date: Oct. 5, 2006

(54) Apparatus measuring angle distribution for neutral beams

(76) Inventor: Sung-Wook Hwang, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/338,678

(22) Filed: Jan. 25, 2006

(30) Foreign Application Priority Data
Mar. 11, 2005 (KR) 10-2005-0020727

(51) Int. Cl. H05H 3/02

(52) U.S. Cl. 250/251

(57) ABSTRACT

There is provided an apparatus for measuring an angle distribution of neutral beams. The apparatus includes a Faraday cup assembly having an opening disposed in a trajectory path of neutral beams supplied from a neutral beam source and receives neutral beam particles, a secondary electron emission plate disposed in the Faraday cup such that the neutral beam particles passing through the opening collide with it to generate secondary electron emissions, and a secondary electron collector disposed to collect the secondary electron emissions.

### BACKGROUND OF THE INVENTION

1. Field of the Invention

Embodiments of the invention relate to an apparatus for measuring the physical characteristics of a neutral beam, such as those used in manufacture of semiconductor devices. More particularly, embodiments of the invention relate to an apparatus for measuring the angle distribution of a neutral beam.

This application claims the priority to Korean Patent Application No. 10-2005-0020727 filed on Mar. 11, 2005, the subject matter of which is incorporated herein by reference.

2. Description of the Related Art

During the manufacture of contemporary semiconductor devices, one or more plasma process(es) may be used for dry etching, physical or chemical vapor deposition, or surface treatment. Conventional plasma processes generally include the steps of applying RF power within a process chamber, supplying a reaction gas into the chamber, dissociating the reaction gas in the chamber, and thus exciting plasma through the use of glow discharge. The excited ions in the plasma may then be applied to a target semiconductor substrate to perform one of the afore-mentioned processes.

With continuing increases in the integration density of semiconductor devices, design rules for the constituent integrated circuits are now in the range of 0.1 microns or less. Therefore, process conditions associated with semiconductor processing apparatuses have become increasingly strict in view of the hyperfine elements required by contemporary semiconductor devices. Accordingly, the performance of plasma processing apparatuses has been enhanced over the past several years. The majorities of these enhancements, however, relate to improvements in plasma density and plasma distribution uniformity.

Such recent enhancements notwithstanding, the performance of conventional plasma processing apparatuses is running up against some basic, inherent, physical use limitations. That is, plasmas by their very nature include a large amount of electrically charged ions. These ions collide with the target substrate (or, more likely, a specific material layer formed on the semiconductor substrate) with great energy, typically ranging up to several hundred electron volts (eV). Unless carefully controlled, colliding plasma ions may cause physical or electrical damage to the target substrate. For example, the surface of a monocrystalline silicon semiconductor substrate may be converted into an amorphous silicon material when impacted by plasma ions. Further, the chemical composition of a specific material layer may actually be altered by plasma ions. In addition, the bonds between atoms forming the semiconductor substrate (or a surface layer formed thereon) may be destroyed by plasma ion collisions, thereby creating dangling bonds. Moreover, problems with specific device structures may also arise from ill-considered use of a plasma process, including charge-up damage to a gate insulation layer, notching of a polysilicon layer due to charging of an associated photoresist, etc.

In order to solve such problems, various methods of manufacturing a semiconductor device have been studied which involve the use of neutral beams rather than ion beams. In such methods, a substrate is processed by first neutralizing the ion beams generated from a plasma and then applying the neutralized beams to the surface of a target substrate. The process of neutralizing the ion beams generally involves forcing ions and neutrons into collision with each other, forcing ions and electrons into collision with each other, or forcing ions into collision with a metal plate.

Of further note, manufacturing processes (e.g., an etching process) applied to semiconductor devices, whether using ion beams or neutral beams, must carefully take into account the angle distribution of the beams being applied to the target substrate. Otherwise, manufacturing yield suffers. For example, assuming an exemplary etching process for purposes of illustration, in order to minimize pattern failure due to the so-called “shadow effect” of a mask pattern, it is necessary to accurately measure the angle distribution of ion beams applied to the target substrate through the mask pattern. A variety of means and methods have been reported to measure the angle distribution of the ion beams applied to this purpose.

For example, a semiconductor device for controlling the angle of ion beams is disclosed in U.S. Pat. No. 5,696,382, the subject matter of which is incorporated by reference herein. However, since neutral beams include electrically neutral particles, the conventional methods applied to the measure of angle distributions for ion beams are not readily applicable.

### SUMMARY OF THE INVENTION

Embodiments of the invention provide an apparatus for effectively measuring an angle distribution for neutral beams. Knowledge regarding the actual angle distribution of neutral beams allows neutral beams to be more accurately used in the manufacture of a semiconductor device.

Thus, in one embodiment, the invention provides an apparatus for measuring an angle distribution for neutral beams, the apparatus comprising; a Faraday cup assembly comprising an opening aligned with an incident axis defined in relation to a trajectory path for neutral beams supplied from a neutral beam source, a secondary electron emission plate disposed within the Faraday cup assembly opposite the opening such that neutral beam particles passing through the opening collide therewith and adapted to generate secondary electrons in response thereto, and a secondary electron collector disposed within the Faraday cup assembly and adapted to receive the secondary electrons.

In one related aspect of this embodiment, the opening is formed with a hole shape having a diameter ranging up to about 10 mm. In another related aspect, the opening is formed with an aspect ratio greater than 5 to 1.

In yet another aspect, the Faraday cup assembly comprises an outer Faraday cup assembly and an inner Faraday cup assembly, wherein the opening comprises an outer opening formed in a top surface of the outer Faraday cup assembly and an inner opening formed in a top surface of the inner Faraday cup assembly, and wherein the top surface of the outer Faraday cup assembly and the top surface of the inner Faraday cup assembly are separated by a defined distance, disposed in parallel one to another, and disposed perpendicular to the incident axis.

In yet another aspect, the Faraday cup assembly comprises a Faraday cup comprising; a bottom surface, an outer cover forming a top surface, and an inner cover disposed between the top and bottom surfaces, in parallel with and separated from the outer cover by a defined distance, wherein the opening comprises an outer opening formed in the outer cover and the inner opening formed in the inner cover.

In another embodiment, the invention provides an apparatus for measuring an angle distribution for neutral beams, the apparatus comprising; a Faraday cup assembly comprising an opening aligned with an incident axis defined in relation to a trajectory path for neutral beams supplied from a neutral beam source, a secondary electron emission plate disposed within the Faraday cup assembly opposite the opening such that neutral beam particles passing through the opening collide therewith and adapted to generate secondary electrons in response thereto, and a secondary electron collector disposed within the Faraday cup assembly and adapted to receive the secondary electrons and generate a secondary current in response thereto, a current measuring unit adapted to measure the secondary electron current, an angle varying unit adapted to vary an arrangement angle of the Faraday cup assembly, and an angle calculating unit adapted to calculate the angle distribution for the neutral beams by analyzing the arrangement angle of the Faraday cup assembly and variations in the secondary electron current in relation to the arrangement angle.

### BRIEF DESCRIPTION OF THE DRAWINGS

Several embodiments of the invention will be described with reference to the accompanying drawings. Throughout the drawings and the associated written description like reference numerals indicate like or similar elements. In the drawings:

FIG. (FIG.) 1 is a schematic diagram illustrating a Faraday cup assembly for measuring an angle distribution of neutral beams according to an embodiment of the invention;

FIG. 2 is a schematic diagram illustrating a Faraday cup assembly for measuring an angle distribution of neutral beams according to another embodiment of the invention;

FIG. 3 is a schematic diagram illustrating a Faraday cup assembly for measuring an angle distribution of neutral beams according to still another embodiment of the invention;

FIG. 4 is a schematic diagram illustrating an apparatus for measuring an angle distribution of neutral beams according to yet another embodiment of the invention; and

FIG. 5 is a block diagram further illustrating the apparatus shown in FIG. 4.

### DETAILED DESCRIPTION OF THE INVENTION

Several embodiments of the invention will now be described in some additional detail. However, the present invention is not limited to only the exemplary embodiments, but may be embodied in many different forms. Rather, the exemplary embodiments are provided as teaching examples. FIG. 1 is a schematic diagram illustrating a Faraday cup assembly adapted to measure an angle distribution for neutral beams according to an embodiment of the present invention. Referring to FIG. 1, an exemplary Faraday cup assembly 14 comprises an outer Faraday cup assembly 10 and an inner Faraday cup assembly 12. The outer Faraday cup assembly 10 comprises an outer Faraday cup 10b and an outer cover 10a forming a top surface of the outer Faraday cup assembly 10. The inner Faraday cup assembly 12 comprises an inner Faraday cup 12b and an inner cover 12a forming a top surface of the inner Faraday cup assembly 12. As shown in FIG. 1, the inner Faraday cup assembly 12 is disposed within the outer Faraday cup assembly 10, and the inner Faraday cup assembly 12 and the outer Faraday cup assembly 10 are electrically isolated from each other.

An outer opening 11 adapted to receive neutral beam particles supplied from an external neutral beam source is provided in the outer cover 10a. An inner opening 13 adapted to receive the neutral beam particles passing through the outer opening 11 is provided in the inner cover 12a. The outer opening 11 and the inner opening 13 may be formed as aligned holes or slots. When the outer opening 11 and the inner opening 13 are formed as holes, the outer opening 11 and the inner opening 13, at least in one embodiment, will have the same diameter ranging up to about 10 mm. According one embodiment of the invention, the outer opening 11 and the inner opening 13 are aligned along an incident axis 15 perpendicular to a horizontal plane defined by the outer cover 10a and inner cover 12a. (Clearly, terms like “horizontal”, “vertical”, “above”, below, “top”, “bottom”, etc. are relative terms drawn for the sake of clarity to the illustrated example. Only the respective spatial relationships communicated by these terms are meaningful in the context of this description. The invention is not limited to any particular spatial geometry or use disposition by these terms).

Thus, in one embodiment, the outer cover 10a and the inner cover 12a are disposed in parallel and spaced apart from each other, and the outer opening 11 and the inner opening 13 are aligned along the incident axis 15 perpendicular to the parallel horizontal planes defined by the outer cover 10a and the inner cover 12a, respectively. In one more specific example, it is preferable that the ratio of the vertical distance along the incident axis between the outer opening 11 and the inner opening 13 to the common diameter of the outer opening 11 and the inner opening 13 is at least 5 to 1.

With this configuration, only the neutral beam particles having an angle of trajectory (N) substantially aligned with the incident axis 15 will pass through the outer opening 11 and the inner opening 13 to be selectively received in the inner Faraday cup assembly 12. Neutral beam particles having an angle of trajectory (generally denoted as N′) substantially aligned with an axis other than the incident axis 15 will not be received in the inner Faraday cup assembly 12. That is, only the neutral beam particles N moving substantially in parallel with the incident axis 15 will be selectively received in the inner Faraday cup assembly 12. As a result, the resolution of the angle distribution for the neutral beams, as measured by the exemplary apparatus, may be controllably enhanced or diminished in relation to the ration established between (1) the distance between the outer opening 11 and inner opening 13, and (2) the diameter of the respective openings. For example, as the distance between the outer opening 11 and the inner opening 13 increases relative to a fixed, common diameter size, the resolution of the measured angle distribution for the neutral beams is enhanced.

Returning to the example shown in FIG. 1, a secondary electron emission plate 16 with which the neutral beam particles received through the outer opening 11 and the inner opening 13 collide is provided in the inner Faraday cup assembly 12. The secondary electron emission plate 16 may in one embodiment be disposed at the bottom of the inner Faraday cup assembly 13 opposite the inner opening 13. In one related aspect of a specific embodiment, the secondary electron emission plate 16 comprises a metal plate having a high secondary electron emission yield. It is generally preferable that the secondary electron emission plate 16 be electrically isolated from the inner Faraday cup assembly 12.

A secondary electron collector 18 adapted to collect secondary electrons (e′) generated by the collision of the neutral beam particles N received in the inner Faraday cup assembly 12 with the secondary electron emission plate 16 may be disposed above the secondary electron emission plate 16 in the inner Faraday cup assembly 12. The secondary electron collector 18 may be formed from any conductive material such as a metal or metal alloy. The secondary electron collector 18 is electrically isolated from the inner Faraday cup assembly 12 and the secondary electron emission plate 16 and is electrically connected to a current measuring unit as described hereafter.

As described above, the apparatus for measuring an angle distribution of neutral beams according to on embodiment of the invention includes the secondary electron emission plate 16, which is adapted to emit secondary electrons (e′) in response to neutral beam collisions, and the secondary electron collector 18 adapted to collect the secondary electrons (e′) emitted from the secondary electron emission plate 16, and thereby measure the amount of neutral beam particles passing through the outer opening 11 and the inner opening 13 to the inner Faraday cup assembly 12. As a result, it is possible to measure the angle distribution of the neutral beams which are electrically neutral.

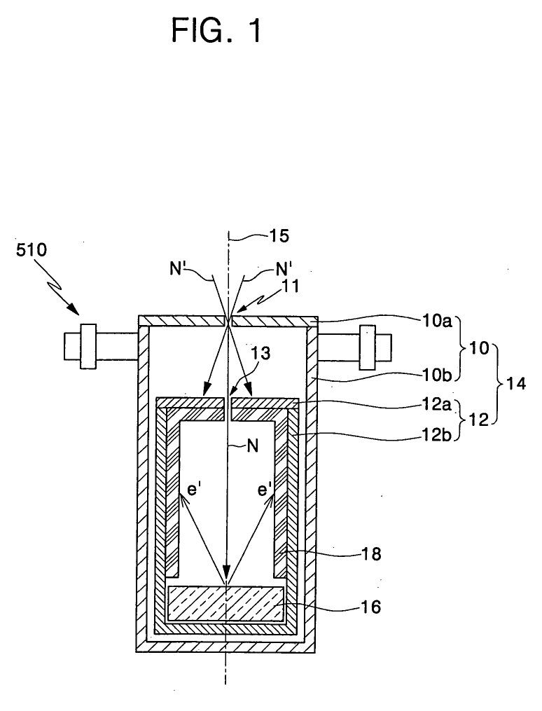

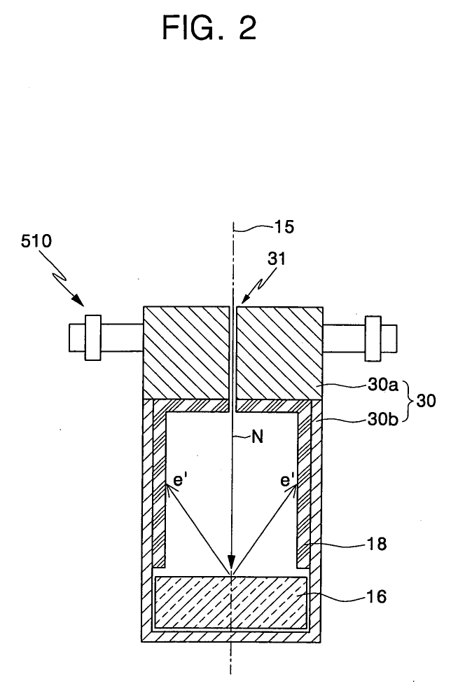

FIG. 2 is a schematic diagram illustrating a Faraday cup assembly for measuring an angle distribution of neutral beams according to another embodiment of the invention. Referring to FIG. 2, a Faraday cup assembly 30 comprises a Faraday cup 30b and a cover 30a forming a top surface of the Faraday cup 30b. The cover 30a is provided with an opening 31 defining an angle of neutral beam particles received into the Faraday cup assembly 30. The opening 31 may take the shape of a hole having a diameter ranging up to about 10 mm. The opening 31 has a depth defined by the thickness of the cover 30a. That is, unlike the Faraday cup assembly 14 shown in FIG. 1, the angle of the neutral beam particles N received into the Faraday cup assembly 30b is defined by the single opening 31 having a predetermined aspect ratio. In this case, it is preferable that the opening 31 has an aspect ratio greater than 5:1. Otherwise, the former description given in relation to FIG. 1 may be applied to FIG. 2.

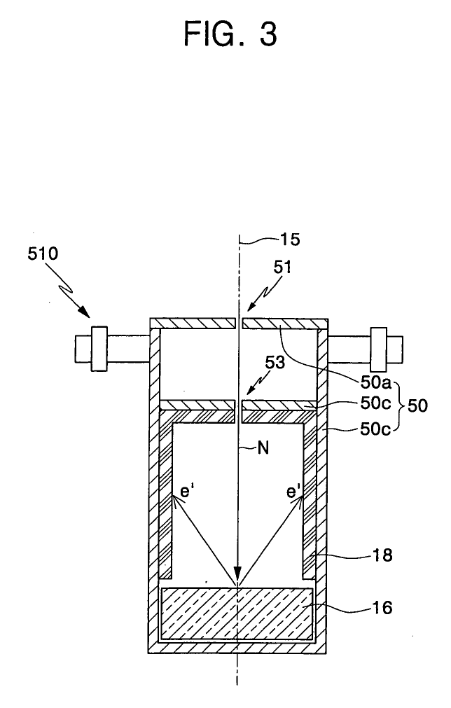

FIG. 3 is a schematic diagram illustrating a Faraday cup assembly for measuring an angle distribution of neutral beams according to still another embodiment of the invention. Referring to FIG. 3, the Faraday cup assembly 50 comprises a single Faraday cup 50c having an outer cover 50a, and an inner cover 50b. The outer cover 50a form a top surface of the Faraday cup 50c and the outer cover 50a is provided with an outer opening 51 for receiving neutral beam particles N. The inner cover 50b is disposed in parallel with the outer cover 50a between a bottom surface of the Faraday cup 50c and the outer cover 50a, and an inner opening 53 is provided in the inner cover 50b. As shown in FIG. 3, it is preferable that the outer opening 51 and the inner opening 53 be aligned along the incident axis 15 perpendicular to a horizontal plane defined by the outer cover 50a. The outer opening 51 and the inner opening 53 may be formed with a common diameter ranging, for example, up to about 10 mm. In addition, a ratio of the distance between the outer opening 51 and the inner opening 53 disposed along the incident axis 15 to the common diameter of the outer opening 51 and the inner opening 53 is greater than 5:1. The secondary electron emission plate 16 and the secondary electron collector 18 shown in FIG. 1 are disposed in the Faraday cup 50c.

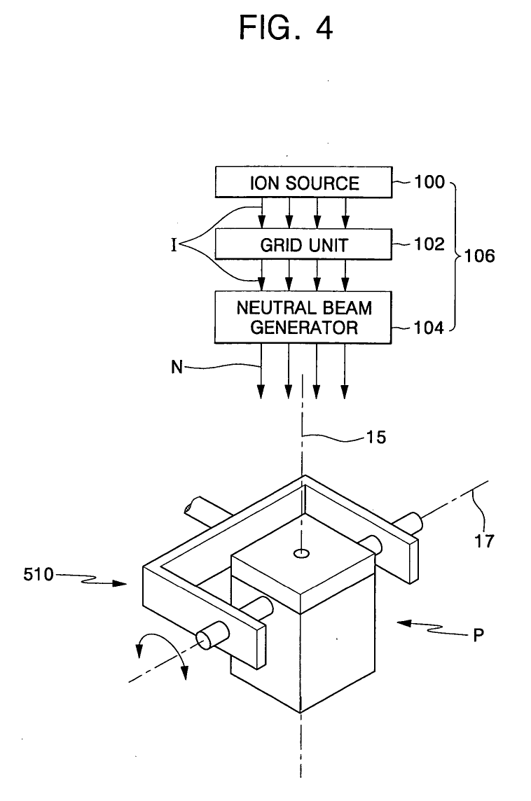

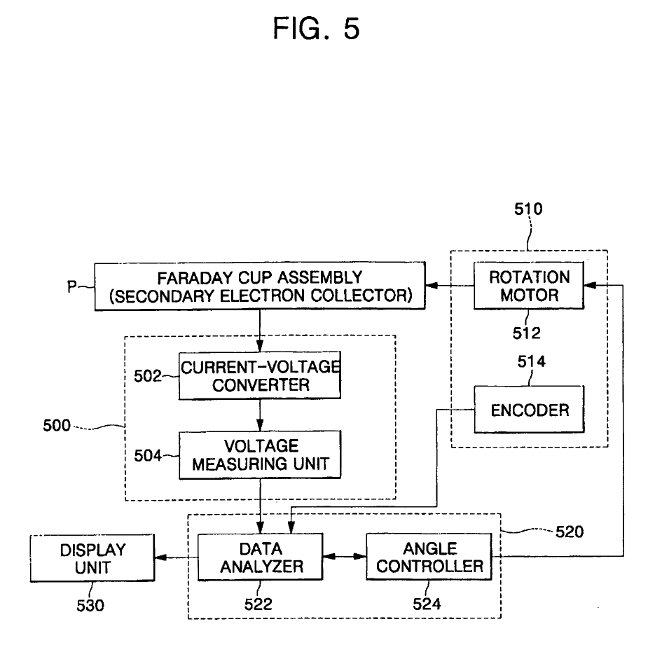

FIG. 4 is a schematic diagram illustrating an apparatus for measuring an angle distribution of neutral beams according to another embodiment of the invention, and FIG. 5 is a block diagram further illustrating the apparatus shown in FIG. 4.

Referring collectively to FIGS. 4 and 5, a Faraday cup assembly P for receiving neutral beam particles is disposed in a trajectory path for neutral beams N supplied from a neutral beam source 106. In one embodiment, the neutral beam source 106 comprises an ion source 100, a grid unit 102, and a neutral beam generator 104. However, if the ion source 100 is adapted to generate ion beams from a variety of reaction gases, it may be sufficient in and of itself. The ion source 100 may, for example, comprise an inductivity coupled plasma (ICP) generator or a capacitively coupled plasma (CCP) generator. The ion beams generated by the ion source 100 are accelerated along their trajectory as they pass through a via hole provided in the grid unit 102, and are thereafter converted into neutral beams as they pass through the neutral beam generator 104. In one embodiment, the neutral beam generator 104 comprises a reflecting plate assembly including a plurality of reflecting plates made of metal, such as tantalum, platinum, molybdenum, tungsten, aurum, or stainless steel. The ion beams having passed through the grid unit 102 collide with the reflecting plate, lose electrical charges, and are converted into the neutral beams.

The Faraday cup assembly P shown in FIG. 4 may be constructed in a manner consistent with the present invention as taught by the examples illustrated in FIGS. 1 through 3. However implemented, the Faraday cup assembly P is connected to an angle varying unit 510 adapted to vary the angular alignment of the Faraday cup assembly P relative to the incident axis 15. In one embodiment, the incident axis 15 may be established in relation to the expected nominal trajectory path for neutral beam particles output by the neutral beam source 106. In some embodiments, the angle varying unit 510 may allow the Faraday cup assembly P to rotate about a rotation axis 17 included in the horizontal plane perpendicular to the nominal trajectory path of the neutral beams and which includes the opening (e.g., elements 11, 31, or 51 above). In one embodiment, the Faraday cup assembly P can repeatedly and controllably rotate between about +30 degree and −30 degree about the rotation axis 17 by means of the angle varying unit 510.

Using this exemplary system, the rotation angle can be measured when the incident axis 15 and the trajectory path of the neutral beams are parallel to each other. At this time, the angle distribution of the neutral beams N can be measured by estimating the amount of neutral beam particles received in the Faraday cup assembly P in accordance with variation of the arrangement angle of the Faraday cup assembly P, that is, the angle of the incident axis 15. The amount of neutral beam particles can be measured by using secondary electron current generated by the secondary electrons e′ collected in the secondary electron collector 18. In this case, the secondary electron current can be measured in real time whenever the Faraday cup assembly P rotates by 1 degree, and the range of the rotation angle and the angle for measuring the secondary electron current can be variously changed in accordance with working conditions.

The angle varying unit 510 may comprise in one embodiment a driving unit comprising a rotation motor 512 adapted to rotate the Faraday cup assembly P about the rotation axis 17, and an angle measuring unit comprising an encoder 514 adapted to measure the rotation angle of the Faraday cup assembly P rotating with the rotation motor 512.

The secondary electron collector 18 in Faraday cup assembly P is electrically connected to a current measuring unit 500 adapted to measure the secondary electron current generated by the secondary electrons. The current measuring unit 500 may in one embodiment comprise a current-voltage converter 502 and a voltage measuring unit 504. The current-voltage converter 502 may include a capacitor connected to the secondary electron collector 504 and the secondary electron current is stored in the capacitor. The capacitor may be connected to the voltage measuring unit 504 and the voltage measuring unit 504 measures the voltage of the capacitor. The measured voltage of the capacitor is transmitted to an angle calculating unit 520 and a data analyzer 522. On the other hand, the current measuring unit 500 may include an ammeter for directly measuring the secondary electron current.

The angle calculating unit 520 may include an angle controller 524 which controls operations of the data analyzer 522 for analyzing the variation of the secondary electron current and the rotation angle in response to the rotation of the Faraday cup assembly P and the rotation motor 512 for allowing the Faraday cup assembly P to rotate to adjust the arrangement angle of the Faraday cup assembly P. The data analyzer 522 can be connected to a display unit 530 for displaying the variation of the secondary electron current corresponding to the variation of the rotation angle.

According to the present invention as described in relation to several embodiments, the secondary electron emission plate which emits the secondary electrons through the collision with the neutral beam particles and the secondary electron collector which collects the secondary electrons are disposed inside the Faraday cup assembly. As a result, it is possible to measure the angle distribution of the neutral beams, which are electrically neutral, by analyzing the secondary electron current in response to the rotation of the Faraday cup assembly.

In addition, the Faraday cup assembly includes the dual openings spaced apart from each other along an incident axis or the single opening having a defined aspect ratio, such that neutral beam particles aligned with the incident axis are received in the Faraday cup assembly. As a result, it is possible to measure the angle distribution of the neutral beams with an enhanced resolution.

The foregoing embodiments may be the subject of various modifications, and design variations. The present invention encompasses all such modifications and variations and is not limited to only the illustrated example. Indeed, the scope of the invention is defined by the following claims.

What is claimed is:

1. An apparatus for measuring an angle distribution for neutral beams, the apparatus comprising:
a Faraday cup assembly comprising an opening aligned with an incident axis defined in relation to a trajectory path for neutral beams supplied from a neutral beam source;
a secondary electron emission plate disposed within the Faraday cup assembly opposite the opening such that neutral beam particles passing through the opening collide therewith and adapted to generate secondary electrons in response thereto; and
a secondary electron collector disposed within the Faraday cup assembly and adapted to receive the secondary electrons.

2. The apparatus of claim 1, wherein the opening is formed with a hole shape having a diameter ranging up to about 10 mm.

3. The apparatus of claim 1, wherein the opening is formed with an aspect ratio greater than 5 to 1.

4. The apparatus of claim 1, wherein the Faraday cup assembly comprises an outer Faraday cup assembly and an inner Faraday cup assembly; and,
wherein the opening comprises an outer opening formed in a top surface of the outer Faraday cup assembly and an inner opening formed in a top surface of the inner Faraday cup assembly, and
wherein the top surface of the outer Faraday cup assembly and the top surface of the inner Faraday cup assembly are separated by a defined distance, disposed in parallel one to another, and disposed perpendicular to the incident axis.

5. The apparatus of claim 4, wherein the outer opening and the inner opening are formed in common with a hole shape having a diameter ranging up to about 10 mm.

6. The apparatus of claim 5, wherein the ratio between the defined distance and the diameter of the outer and inner openings is greater than 5 to 1.

7. The apparatus of claim 1, wherein the Faraday cup assembly comprises a Faraday cup comprising; a bottom surface, an outer cover forming a top surface, and an inner cover disposed between the top and bottom surfaces, in parallel with and separated from the outer cover by a defined distance; and
wherein the opening comprises an outer opening formed in the outer cover and the inner opening formed in the inner cover.

8. The apparatus of claim 7, wherein the outer and inner openings are commonly formed with hole shape having a diameter ranging up to about 10 mm.

9. The apparatus of claim 7, wherein the ratio between the defined distance and the diameter is greater than 5 to 1.

10. The apparatus of claim 1, further comprising:
an angle varying unit adapted to vary an arrangement angle of the Faraday cup assembly.

11. The apparatus of claim 10, wherein the angle varying unit is further adapted to rotate the Faraday cup assembly about a rotation axis parallel to a horizontal plane defined by the top surface, passing through the outer opening, and perpendicular to incident axis.

12. An apparatus for measuring an angle distribution for neutral beams, the apparatus comprising:
a Faraday cup assembly comprising an opening aligned with an incident axis defined in relation to a trajectory path for neutral beams supplied from a neutral beam source;
a secondary electron emission plate disposed within the Faraday cup assembly opposite the opening such that neutral beam particles passing through the opening collide therewith and adapted to generate secondary electrons in response thereto; and
a secondary electron collector disposed within the Faraday cup assembly and adapted to receive the secondary electrons and generate a secondary current in response thereto;
a current measuring unit adapted to measure the secondary electron current;
an angle varying unit adapted to vary an arrangement angle of the Faraday cup assembly; and
an angle calculating unit adapted to calculate the angle distribution for the neutral beams by analyzing the arrangement angle of the Faraday cup assembly and variations in the secondary electron current in relation to the arrangement angle.

13. The apparatus of claim 12, wherein the opening is formed with a hole shape having a diameter ranging up to about 10 mm.

14. The apparatus of claim 12, wherein the opening is formed with an aspect ratio greater than 5 to 1.

15. The apparatus of claim 12, wherein the Faraday cup assembly comprises an outer Faraday cup assembly and an inner Faraday cup assembly; and,
wherein the opening comprises an outer opening formed in a top surface of the outer Faraday cup assembly and an inner opening formed in a top surface of the inner Faraday cup assembly, and
wherein the top surface of the outer Faraday cup assembly and the top surface of the inner Faraday cup assembly are separated by a defined distance, disposed in parallel one to another, and disposed perpendicular to the incident axis.

16. The apparatus of claim 15, wherein the outer opening and the inner opening are formed in common with a hole shape having a diameter ranging up to about 10 mm.

17. The apparatus of claim 16, wherein the ratio between the defined distance and the diameter of the outer and inner openings is greater than 5 to 1.

18. The apparatus of claim 12, wherein the Faraday cup assembly comprises a Faraday cup comprising; a bottom surface, an outer cover forming a top surface, and an inner cover disposed between the top and bottom surfaces, in parallel with and separated from the outer cover by a defined distance; and
wherein the opening comprises an outer opening formed in the outer cover and the inner opening formed in the inner cover.

19. The apparatus of claim 18, wherein the outer and inner openings are commonly formed with hole shape having a diameter ranging up to about 10 mm.

20. The apparatus of claim 18, wherein the ratio between the defined distance and the diameter is greater than 5 to 1.

21. The apparatus of claim 12, wherein the current measuring unit comprises:
a current-voltage converter connected to the secondary electron collector and adapted to convert the secondary electron current into a corresponding voltage; and
a voltage measuring unit adapted to measure the corresponding voltage and supply measured data to the angle calculating unit.

22. The apparatus of claim 12, wherein the angle varying unit is further adapted to rotate the Faraday cup assembly about a rotation axis passing through the opening and perpendicular to the incident axis.

23. The apparatus of claim 22, wherein the angle varying unit comprises:
a driving unit adapted to rotate the Faraday cup assembly; and
an angle measuring unit adapted to measure a rotation angle of the Faraday cup assembly as rotated by the driving unit.

24. The apparatus of claim 23, wherein the driving unit comprises a rotation motor adapted to rotate the Faraday cup assembly, and
wherein the angle measuring unit comprises an encoder associated with the rotation motor.

25. The apparatus according to claim 12, wherein the angle calculating unit comprises:
a data analyzer adapted to analyze variation of the secondary electron current in relation to variation of the arrangement angle and further adapted to calculate a tilted angel for the neutral beam particles; and
an angle controller adapted to control the arrangement angle.

26. The apparatus according to claim 12, further comprising a display unit adapted to display in real time the arrangement angle of the Faraday cup assembly and the corresponding secondary electron current.
